(19) United States
(12) Patent Application Publication
(10) Pub. No.: US 2024/0409195 A1
(43) Pub. Date: Dec. 12, 2024

(54) COMMUNICATING DIVING MASK

(71) Applicants: Jean-Philippe THOME, Clermont-Ferrand (FR); Sébastien PASCAL, Castillon Du Gard (FR); Sophie MORICE, Antibes Juan Les Pins (FR)

(72) Inventor: JEAN-PHILIPPE THOME, Clermont-Ferrand (FR)

(21) Appl. No.: 18/736,687

(22) Filed: Jun. 7, 2024

(30) Foreign Application Priority Data
Jun. 8, 2023 (EP) 23178162.6

(51) Int. Cl. B63C 11/26; B63C 11/16

(52) U.S. Cl. CPC B63C 11/26; B63C 11/16

(57) ABSTRACT

The invention is for a communicating diving mask with a body including a frame (20) surrounding at least part of a user's face; a glass (10) surrounded by the frame (20), where the diving mask has an electromagnetic transducer (23) arranged in contact with the glass to vibrate it; and a microphone (22) arranged in the mask, and a control unit (25) configured to control the vibration of the electromagnetic transducer (23) on the basis of a signal transmitted by the microphone (22).

### TECHNICAL FIELD OF THE INVENTION

The present invention relates to a communicating diving mask. It applies in particular to the aquatic field.

### PRIOR ART

Diving masks are essential equipment for divers, enabling them to see underwater and admire the beauty of the seabed. Diving masks are designed to create an air pocket around the diver's eyes and nose, allowing clear, undistorted vision. They can also help protect eyes from irritants such as sea salt and chlorine in pool water. With a wide variety of models available, diving masks are suitable for different types of diving, from snorkeling to scuba diving.

Some prior art documents also propose diving mask devices. For example, publication FR3064594 proposes a diving mask with a locking device for attaching the snorkel.

However, this invention can have disadvantages and does not facilitate vocal exchanges when speaking underwater.

### DESCRIPTION OF THE INVENTION

The present invention aims to remedy these drawbacks with a totally innovative approach.

More specifically, the aim of the invention is to provide a communicating diving mask.

In particular, it is a goal of the invention to provide such a technique that dispenses with any other complex adjustment system.

These objectives, as well as others that will appear later, are achieved, according to a first aspect, with the aid of a diving mask, said diving mask comprising a body including a frame surrounding at least a portion of a user's face; a glass 10 surrounded by the frame; characterized in that said diving mask comprises:
an electromagnetic transducer arranged in contact with the glass 10 to cause it to vibrate; and
a microphone arranged in the mask, and
a control unit configured to control the vibration of the electromagnetic transducer 23 on the basis of a signal transmitted by the microphone 22.

Thanks to these arrangements, the result is to vibrate the wall of the mask or glass 10, which thus acts like a loudspeaker membrane radiating sound into the water.

In one example, the electromagnetic transducer 23 is consistent with application WO 2022/008685 A1.

The invention is advantageously implemented according to the following embodiments and variants, which are to be considered individually or in any technically effective combination.

In one embodiment, the diving mask comprises a snorkel, a flexible skirt attached to the frame, the skirt comprising a partition separating a first chamber for vision from a second chamber for breathing, the partition being arranged to rest above the nose of a user of the diving mask so that the mouth and nose of the user are accommodated in the second chamber, and the eyes of the user are accommodated in the first chamber, the diving mask further preferentially comprising a snorkel (21) in fluid communication with the first chamber.

In one embodiment, said microphone 22 is housed in the second chamber, preferentially close to the user's mouth.

In one embodiment, at least one of the control unit, electromagnetic transducer 23 and microphone 22 is sealed, with each of the control unit, the electromagnetic transducer 23 and microphone 22 preferentially being sealed.

The electromagnetic transducer 23 is preferentially bonded to the glass, for example using a cyanoacrylate adhesive or a polyepoxy (or epoxy polymer) adhesive.

In one embodiment, the electromagnetic transducer 23 and microphone 22 are connected to the control unit by a respective cable, each cable preferentially being at least partially housed in the frame.

In one embodiment, the control unit comprises a preferentially rechargeable electric power source.

In one embodiment, said light source is preferentially powered by the control unit.

In one embodiment, the control unit comprises a signal processing module for processing the signal supplied by microphone 22, said processing module being preferentially adapted to apply filtering to said signal, such as band filtering, equalization and/or feedback suppression.

In one embodiment, the diving mask further comprises an accessory holder suitable for receiving an accessory, such as a camera, preferentially of the waterproof type, or an additional light source.

In one embodiment, the snorkel comprises a valve, the valve comprising:
a valve orifice for enabling fluid circulation, in particular of air, between the outside of the snorkel and the inside of the snorkel, and
a valve closure member movable between an open position wherein the valve port is open and a closed position wherein the valve port is closed by the valve closure member,
   wherein the snorkel preferentially comprises an inhaled air intake channel and at least one first exhaled air exhaust channel, said snorkel being the extension of an upper part of the frame, the inhaled air intake channel leading into the upper chamber while the first exhaled air exhaust channel communicates with the lower chamber, and wherein the first conduit of the frame has an upper end leading into the exhaled air exhaust channel.

### BRIEF DESCRIPTION OF FIGURES

Further advantages, purposes and features of the present invention will be apparent from the following description, which is made for the purpose of explanation and which is by no means limiting, with reference to the appended drawings, wherein:

FIG. 1 shows a front view of a diving mask according to the invention.

FIG. 2 shows a profile view of the diving mask shown in FIG. 1A.

### DESCRIPTION OF EMBODIMENTS

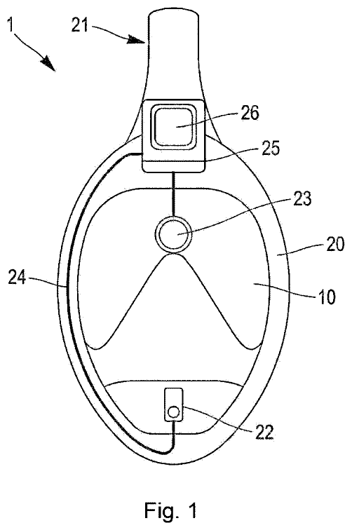

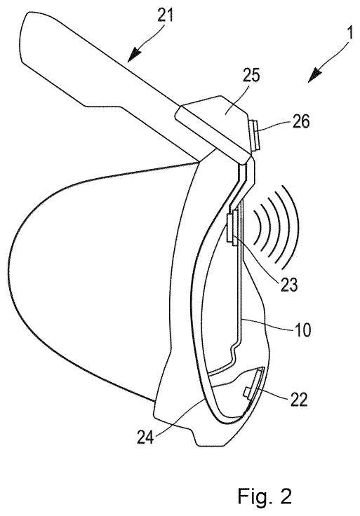

FIGS. 1 and 2 show a diving mask in profile view.

A diving mask is an essential piece of protective equipment for divers. This is a device that enables clear underwater vision by creating a pocket of air in front of the diver's eyes.

The diving mask comprises a body, a snorkel 21, and a flexible skirt.

Alternatively, the diving mask can be snorkel-less, especially for professional and/or deep diving.

According to one example, said body comprises a frame 20 surrounding at least a portion of a user's face, and a glass 10 which is surrounded by said frame 20.

A glass 10 is a piece of protective equipment that covers the face, in particular the eyes, nose and mouth, in the present embodiment the eyes, to protect against water ingress, splashes, particle projections or light radiation. Said flexible skirt comprises a partition.

According to one example, the partition delimits two chambers, a first chamber for vision, and a second chamber for the user's breathing.

The snorkel 21 of the diving mask features a valve, an air intake channel and at least one first exhaust channel for exhaled air.

The air intake channel opens into the second chamber, and the first exhaled-air exhaust channel communicates with the second chamber.

The use of the air intake channel allows air to circulate from the user's mouth to the mouthpiece of snorkel 21.

In one embodiment, the frame duct 20 has an upper end which opens into the exhaled-air exhaust channel.

A valve is a mechanical device used to control the flow of fluids, such as water, air, gas, vapors, etc. It is generally used to regulate the pressure, flow or direction of fluid flow in a system.

The valve comprises an orifice and a closure member.

The closure member is a member used to control the flow of fluid in a pipe. It can be operated manually or automatically and can take different forms depending on the type of valve.

In one example, the closure member moves to either an open or a closed position.

In one example, the valve is used to drain off any water that may seep into the diving mask.

In one embodiment, the diving mask comprises the following elements: an electromagnetic transducer 23, a microphone 22, and a control unit 25.

An electromagnetic transducer 23 is a device that converts a form of electrical energy into a form of electromagnetic energy and vice versa.

In one example, the electromagnetic transducer 23 is arranged in contact with the glass.

The result is that the wall of the mask or glass 10 vibrates, acting like a loudspeaker membrane radiating sound into the water.

In one example, the electromagnetic transducer 23 is cylindrical in shape.

A microphone 22 is a device that converts sound waves into electrical signals.

The microphone 22 is housed in the second chamber.

In one example, the electromagnetic transducer 23 and microphone 22 are sealed. This prevents any malfunction in the diving mask.

A control unit 25 is an electronic component that manages the operation of a device.

The control unit 25 is positioned on the outer wall of the diving mask.

In one variant, the microphone 22 transmits a signal to the control unit 25 to control the vibration of the electromagnetic transducer 23.

This variant enables a long transmission of the signal.

The electromagnetic transducer 23 and microphone 22 are connected to control unit 25 by cables 24.

In one embodiment, the cables 24 are housed in the frame 20 of the diving mask.

The control unit 25 comprises a power supply and a processing module Said power source is a long-life battery.

A processing module is an electronic component that processes data or signals by performing a series of operations or algorithms.

The processing module processes the signal supplied by microphone 22.

According to one example, the processing module is adapted to apply band filtering, equalization, and/or anti-feedback.

Filtering is a signal processing technique which consists in modifying or removing certain frequencies or components from a signal in order to extract or eliminate certain information.

Applying filtering makes it possible to avoid the Larsen effect.

The Larsen effect, also known as an acoustic feedback loop, is an acoustic phenomenon that occurs when a microphone 22 and a loudspeaker are placed too close together and the sound emitted by the loudspeaker is picked up by the microphone 22, amplified and sent back to the loudspeaker. This feedback process can lead to a gradual increase in volume until the system becomes unstable and produces a high-pitched, unpleasant feedback noise.

In one variant, the diving mask includes a light source 26.

The light source 26 is powered by the control unit 25.

In one embodiment, the light source 26 is a light-emitting diode.

A light-emitting diode is an electronic component that emits light when an electric current flows through it.

In one embodiment, the diving mask includes an accessory holder.

The accessory holder is suitable for accommodating a waterproof camera or an additional light source.

The battery also powers any additional accessories.

In one example, the diving mask has a strap positioned behind the frame 20.

The strap secures the diving mask to the user's head, preventing water from accumulating in the mask.

According to a variant, not shown, a secondary microphone is positioned at the snorkel connected to the control unit to enable sound capture from the surface when the mask is partially submerged with the snorkel emerged to allow the user to breathe. Thus, the sound captured by the secondary microphone can be retransmitted to the user via the electromagnetic transducer. In this way, the user has access to sounds emitted in the open air while his head is underwater.

According to another variant, not shown, advantageously complementary to the above variant, the diving mask can include a loudspeaker positioned at the snorkel connected to control unit 25 to enable the microphone signal to be retransmitted by said loudspeaker.

In a combination of these two variants, the snorkel features a secondary microphone and a loudspeaker connected to the control unit, enabling communication with a subject in the open air while the user has his head underwater. According to this option, sounds emitted in the open air, such as the subject's voice, are captured by the secondary microphone and retransmitted to the user by the electromagnetic transducer 23 and the vibration of the vibrator 10 that it causes. The user's words are captured by the microphone and retransmitted by the open-air loudspeaker.

According to an exemplary embodiment, not shown, based on the same principle as the two variants above, the diving mask 1 features a floating platform comprising a secondary microphone and/or loudspeaker system to enable communication with the outside world when the user's head is underwater.

This floating platform is connected to the control unit by a wire running, for example, through the snorkel.

According to this exemplary embodiment, the floating platform can comprise a support surface equipped with an electromagnetic transducer of the same type as the electromagnetic transducer arranged in contact with the glass 10.

### LIST OF REFERENCE SIGNS

TABLE 1

| References | Designations |
|---|---|
| 1 | diving mask |
| 10 | glass |
| 20 | frame |
| 21 | snorkel |
| 22 | microphone |
| 23 | electromagnetic transducer |
| 24 | cable |
| 25 | control unit |
| 26 | light source |

1. A diving mask (1), said diving mask comprising a body including a frame (20) surrounding at least a portion of a user's face; a glass (10) surrounded by the frame (20); characterized in that said diving mask includes:
an electromagnetic transducer (23) arranged in contact with the glass (10) to vibrate it; and
a microphone (22) arranged in the mask, and
a control unit (25) configured to control the vibration of the electromagnetic transducer (23) on the basis of a signal transmitted by the microphone (22).

2. The diving mask (1) according to claim 1, wherein the diving mask comprises a flexible skirt attached to the frame (20), the skirt comprising a partition separating a first chamber for vision and a second chamber for breathing, the partition being arranged to rest above the nose of a user of the diving mask so that a mouth and nose of the user are accommodated in the second chamber, and eyes of the user are accommodated in the second chamber, the diving mask further preferentially comprising a snorkel (21) in fluid communication with the first chamber.

3. The diving mask (1) according to claim 2, wherein said microphone (22) is housed in the second chamber preferentially close to the user's mouth.

4. The diving mask according to claim 1, wherein at least one of the control unit (25), electromagnetic transducer (23) and microphone (22) is sealed, each of the control unit (25), electromagnetic transducer (23) and microphone (22) being preferentially sealed.

5. The diving mask (1) according to claim 1, wherein the electromagnetic transducer (23) and the microphone (22) are connected to the control unit (25) by a respective cable (24), each of the cables (24) preferentially being at least partially housed in the frame (20).

6. The diving mask (1) according to claim 1, wherein the control unit (25) comprises a preferentially rechargeable power source.

7. The diving mask (1) according to claim 1 comprising a light source, said light source being preferentially powered by the control unit (25).

8. The diving mask (1) according to claim 1, wherein the control unit (25) comprises a signal processing module for processing the signal supplied by the microphone (22), said processing module being preferentially adapted to apply filtering to said signal, such as band filtering, equalization and/or feedback suppression.

9. The diving mask (1) according to claim 1, further comprising an accessory holder suitable for receiving an accessory, such as a camera, preferentially of the waterproof type, or an additional light source.

10. The diving mask (1) according to claim 2 alone, wherein the snorkel (21) comprises a valve, the valve comprising:
a valve orifice for enabling fluid circulation, in particular of air, between the outside of the snorkel (21) and the inside of the snorkel (21), and
a valve closure member movable between an open position wherein the valve port is open and a closed position wherein the valve port is closed by the valve closure member,
wherein the snorkel (21) preferentially comprises an inhaled air intake channel and at least one first exhaled air exhaust channel, said snorkel (21) being the extension of an upper part of the frame (20), the inhaled air intake channel leading into the upper chamber while the first exhaled air exhaust channel communicates with the lower chamber, and wherein the first duct of the frame (20) has an upper end leading into the exhaled air exhaust channel.
